(19) United States
(12) Patent Application Publication
(10) Pub. No.: US 2013/0270090 A1
(43) Pub. Date: Oct. 17, 2013

(54) KEYBOARD

(71) Applicant: Hyung Tae Lee, Seoul (KR)

(72) Inventor: Hyung Tae Lee, Seoul (KR)

(73) Assignees: LEETIS TECHNOLOGY DEVELOPMENT (HK) COMPANY LIMITED; Wenyu, Zhang

(21) Appl. No.: 13/727,034

(22) Filed: Dec. 26, 2012

(30) Foreign Application Priority Data
Apr. 12, 2012 (KR) 10-2012-0037733

(51) Int. Cl. H01H 13/84

(52) U.S. Cl. CPC H01H 13/84
USPC 200/5 A

(57) ABSTRACT

A keyboard includes a keyboard shell, a supporting panel, a plurality of keycaps, a keycap support opposite to the supporting panel, a plurality of elastomer arranged on FPC, a light emitting substrate disposed at a lower side of the supporting panel, a plurality of light emitting members disposed on the light emitting substrate, a FPC sheet, and a flexible support portion of the elastomer having a top part and extending from the top part in an arch shape and a pressure protrusion of the elastomer formed on a bottom surface of the top part, and a conductive layer formed on the surface of the pressure protrusion; the pressure protrusion is opposite to the key signal pad on FPC, the pressure protrusion contacts the key signal pad and is supported by the flexible support portion; the supporting panel has a plurality of receiving holes arranged through a thickness direction.

### FIELD OF THE INVENTION

This invention relates to keyboards, especially to a keyboard with back-light that light beams are irradiated to the keycaps from underside.

### DESCRIPTION OF RELATED ART

Keyboards usually are used for inputting signals to computers by tapping key bodies. Herein in this invention keyboard is an input device used for computer, portable computer and other devices having signals inputting.

Recently, a keyboard that can be used in dim with accurate operations and having light beams irradiated from undersides of the keycaps to the keycaps has been disclosed.

In FIG. 10, an exploded view of typical keyboard is shown. In FIG. 11, a cross-sectional view of a main part of a typical keyboard is shown. In FIG. 12, a cross-sectional view of a FPC sheet of a typical keyboard is shown.

A typical keyboard includes a keyboard shell 111 which has elastomer holes 112a, a supporting panel 112 connected to the keyboard shell 111 as a whole, a plurality of keycaps 113 configured above the elastomer holes 112a, A plurality of keycap supports 130 opposite to the supporting panel 112 for supporting the keycaps 113, an elastomer panel 150 disposed at an underside of the supporting panel 112, a flexible printed circuit (FPC) sheet 160 under the elastomer panel 150, a light defusing panel 117 under the FPC sheet 160, a light emitting part 140 with light emitting substrate 141 under the light defusing panel 117, a main body electrically connected to the FPC sheet 160 and the light emitting part 140, and a rear panel 118 disposed beneath the light emitting substrate 141.

The keyboard shell 111 is made from aluminum or other metal materials, or solid polyresin.

The supporting panel 112 has an upper part penetrating an upper part of the keyboard shell 111 and exposed. The supporting panel 112 and the keyboard shell 111 are connected as a piece of one part.

The keycap support 130 is constituted with an up-down guide portion 131 formed in an underside of the keycap 113, a pressure portion 132 formed inside of the up-down guide portion 131 and a guide rail 133 formed within a scope of a perimeter of a elastomer through hole 112a of the supporting panel 112.

The up-down guide portion 131 has a protrusion 131a in a bottom end thereof. The pressure portion 132 has its bottom end contacting with a top end of an elastomer 151. The guide rail 133 has a limit corner 133a in its upper part.

The protrusion 131a and the limit corner 133a can be buckled with each other.

The keycap support 130 has such a configuration that the keycap 113 is closed to the supporting panel 112 when pressed down.

The elastomer panel 150 has elastomers 151 corresponding to the elastomer holes 112a. The elastomer 151 is arch shaped overall, and a pressure protrusion 151a is formed inside.

The elastomer 151 is made from rubber or other transparent and half-transparent materials.

The FPC sheet 160 has an insulation layer 162, an upper layer 161 and a lower layer 163 attached to both sides of the insulation layer 162 respectively, and a outer connecting pad 164 electrically connected to the upper layer 161 and the lower layer 163.

The insulation layer 162 has a plurality of connecting holes 162a corresponding to the elastomer holes 112a defined therein.

The upper layer 161 and the lower layer 163 have upper key signal pads 161a and lower key signal pads 163a respectively which have the same configuration as the elastomer holes 112a.

The connection terminal 164 is electrically connected to the upper key signal pad 161a, the lower key signal pad 163a and the main board (not shown).

Because the elastomer 151 is pressed by keycap 113 and the pressure protrusion 151a presses the upper layer 161, the upper key signal pad 161a goes through the connecting hole 162a and contacts the lower key signal pad 163a.

When the upper key signal pad 161a is connected to the lower key signal pad 163a, the key signal is in ON state.

When the keycap 113 is released from pressing the elastomer 151, the upper key signal pad 161a leaves the lower key signal pad 163a and the keyboard is in OFF state.

The ON state and the OFF state of the upper key signal pad 161a and the lower key signal pad 163a are sent to a computer through the outer connecting pads 164 and the main board (not shown).

The light defusing panel 117 has arch-shaped lens 117a disposed beneath the elastomers 151. The light emitting part 140 has light emitting substrate 141 and light emitting members 142 disposed on the light emitting substrate 141.

The light emitting substrate 141 is preferably ceramic PCB or other high temperature durable substrate.

The light emitting substrate 141 is electrically connected to the main board (not shown).

The light emitting substrate 141 has light emitting member driving chips which receive controlling signals coming from a computer or an MCU IC of the keyboard through the main body to drive the light emitting members 142 to illuminate. The light emitting members 142 can be light emitting diodes.

The light emitting member 142 with the above-mention configuration is disposed on the light emitting substrate 141 and under the arch-shaped lens 117a.

Light beams emitted from the light emitting members 142 cross the arch-shaped lens 117a and the elastomer 151, and reach the upper side of the supporting panel 112.

The driving voltage of the light emitting member 142 is from a battery in the keyboard shell 111 or from the main body of a computer.

The main board (not shown) is electrically connected to the computer via electric codes.

The rear panel 118 is caved and connected to the keyboard shell 111 with screws.

In the following, the assembling method of the above-described keyboard will be disclosed.

Firstly, the keycaps 113 are installed. The keycap support 130 is supported on the supporting panel 112.

Finally, when the elastomer panel 150, the FPC sheet 160, the light defusing panel 117, and the light emitting substrate 141 are installed between the keyboard shell 111 and the rear panel 118, the rear panel 118 is fastened to the keyboard shell 111 by screws.

The above described keyboard is disclosed in Korean patent with patent application number 54613 (named as light emitting keyboard).

However, the such keyboard has an increased thickness due to the elastomers 151 are formed on the elastomer panel 150 and three individual layers including insulating layer, upper layer and lower layer are formed on FPC sheet 160.

Therefore, it is desirable to provide a keyboard which can overcome the above-mentioned problem.

### BRIEF DESCRIPTION OF THE DRAWINGS

FIG. 1 is a view of a keyboard according to one embodiment of this invention;

FIG. 2 is an exploded view of a keyboard according to one embodiment of this invention, the keyboard including a keycap support, an FPC sheet, a supporting panel, a light emitting substrate, and a elastomer;

FIG. 3 is a rear view of the keyboard in FIG. 2;

FIG. 4 is a view of the keycap support in FIG. 2;

FIG. 5 is a plan view of the FPC sheet in FIG. 2;

FIG. 6 is a plan view of the supporting panel in FIG. 2;

FIG. 7 is a plan view of the light emitting substrate in FIG. 2;

FIG. 8 is a cross-section view along line A-A in FIG. 1;

FIG. 9 is an assembled view of the light emitting substrate, the FPC sheet, the supporting panel and the elastomer;

FIG. 10 is an exploded view of a typical keyboard;

FIG. 11 is a cross sectional view of a typical keyboard;

FIG. 12 is a cross-section view of a FPC sheet of a typical keyboard.

### SUMMARY

This invention discloses a keyboard with decreased thickness.

An exemplary keyboard includes a keyboard shell, a supporting panel on the keyboard shell, a plurality of keycaps above the supporting panel, a keycap support opposite to the supporting panel and used for connecting the keycaps to make the keycaps close to an upper side of the supporting panel when the keycaps being pressed down, a plurality of elastomers through the elastomer holes and exposing to the supporting panel, an light emitting substrate under the supporting panel, a plurality light emitting members on the light emitting substrate which are corresponding to the keycaps, an FPC sheet with corresponding key signal pads to key cap arranged on the support panel, a flexible support part of the elastomer having a top portion in an arch shape, a pressure protrusion of the elastomer formed on a bottom surface of the top end and a conductive layer formed on the outside surface of the pressure protrusion, and the pressure protrusion is opposite to the key signal pad, and when the keycap is pressed down, the pressure protrusion contacts the signal pad, and the flexible support part provides the support to the elastomer, and a plurality of lighting emitting members arranged on the light emitting substrate, and the light emitting members get in the light through holes on supporting panel.

Herein, to prevent the decrease of the contact area between the supporting panel and the FPC sheet for seamless contact, the light emitting members are disposed on the light emitting substrate does not exceed the upper side surface of the supporting panel.

Furthermore, the keycap support includes a pair of connection parts in which the connection parts are intersected with each other in a middle part, and upper parts and lower parts are connected to a support protrusion of the keycap and the supporting panel, which has a scissor shape.

Furthermore, the elastomer is made of transparent materials.

Furthermore, the keyboard shell is made of Aluminum or other mental material, or polyresin.

This invention has a single layer of FPC sheet, and a conductive layer on the pressure protrusion of the elastomer. When the keycap is pressed, the pressure protrusion moves down and the conductive layer in elastomer contacts the another conductive layer on FPC (ON state). Such single layer FPC is helpful to the keyboard thickness reduction.

### DETAILED DESCRIPTION

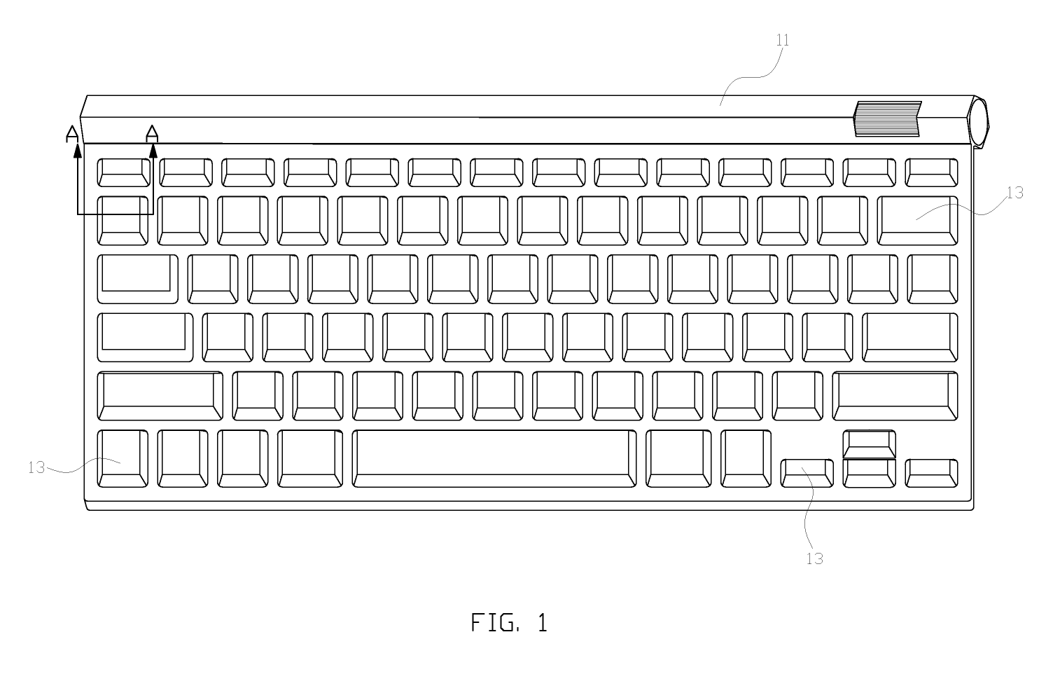

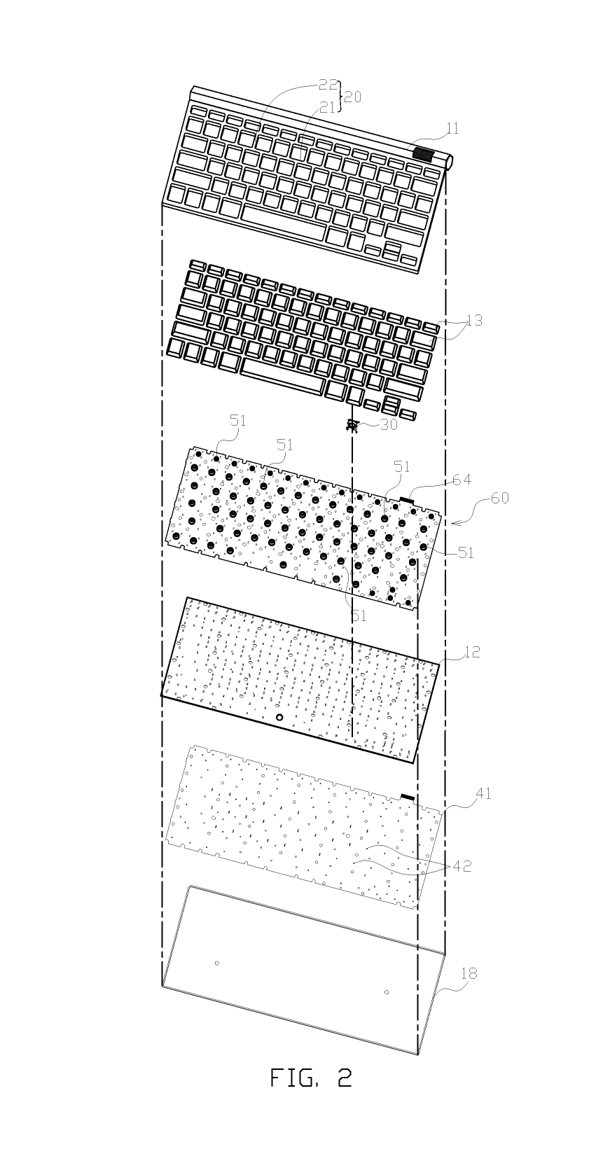

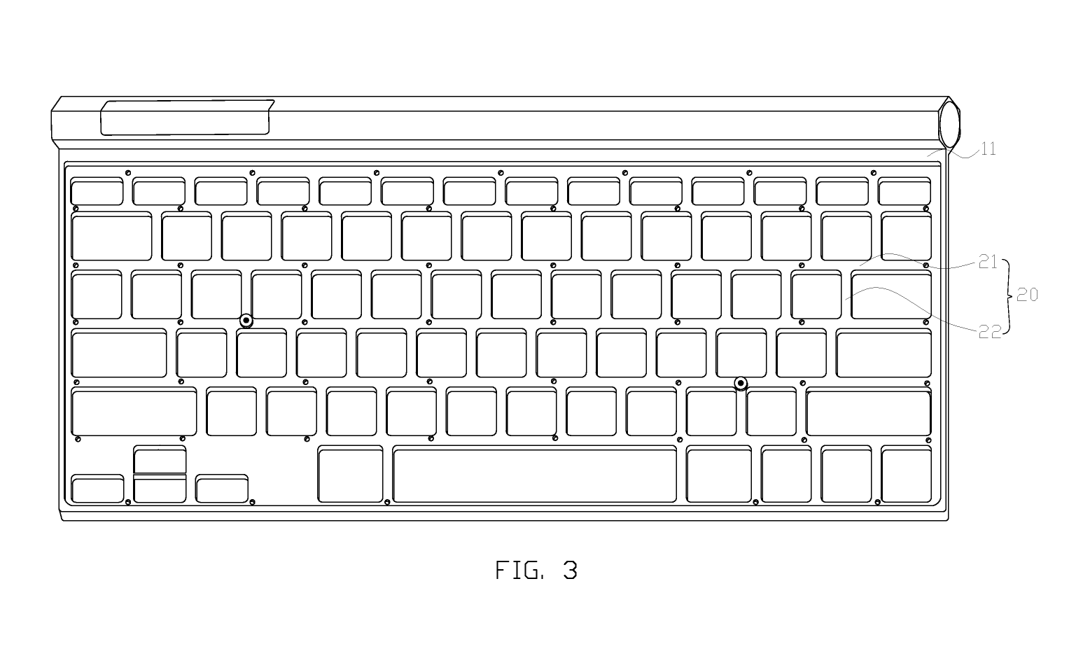

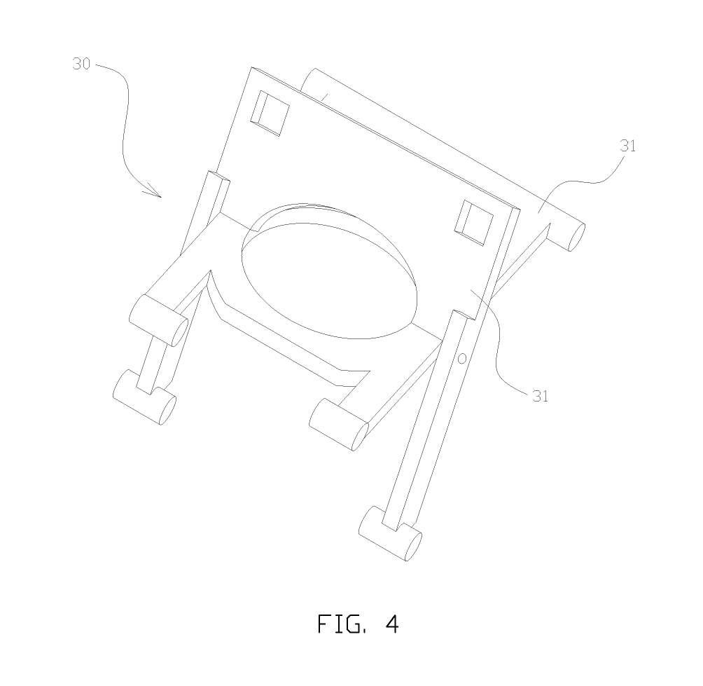

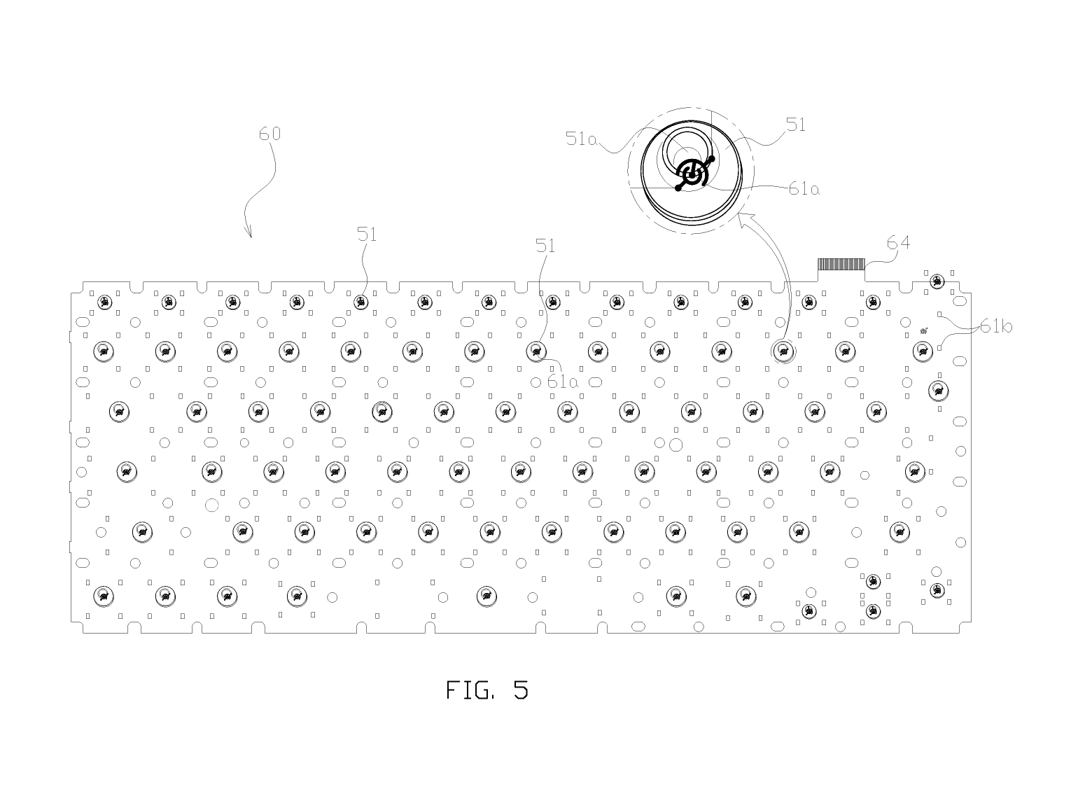

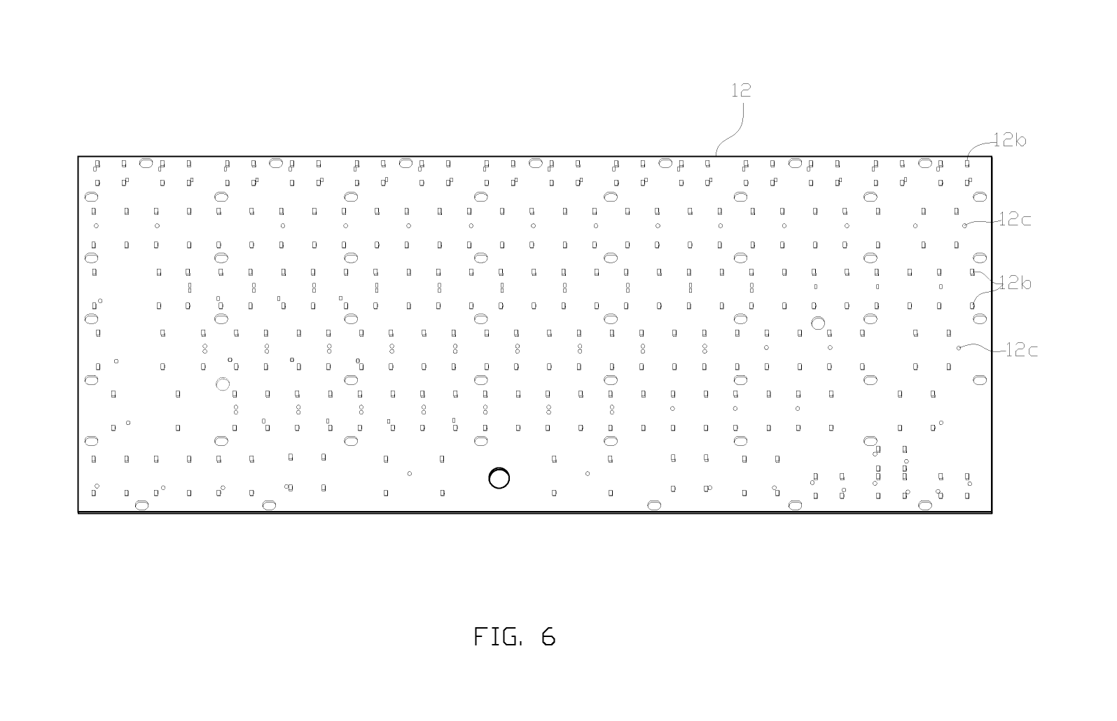

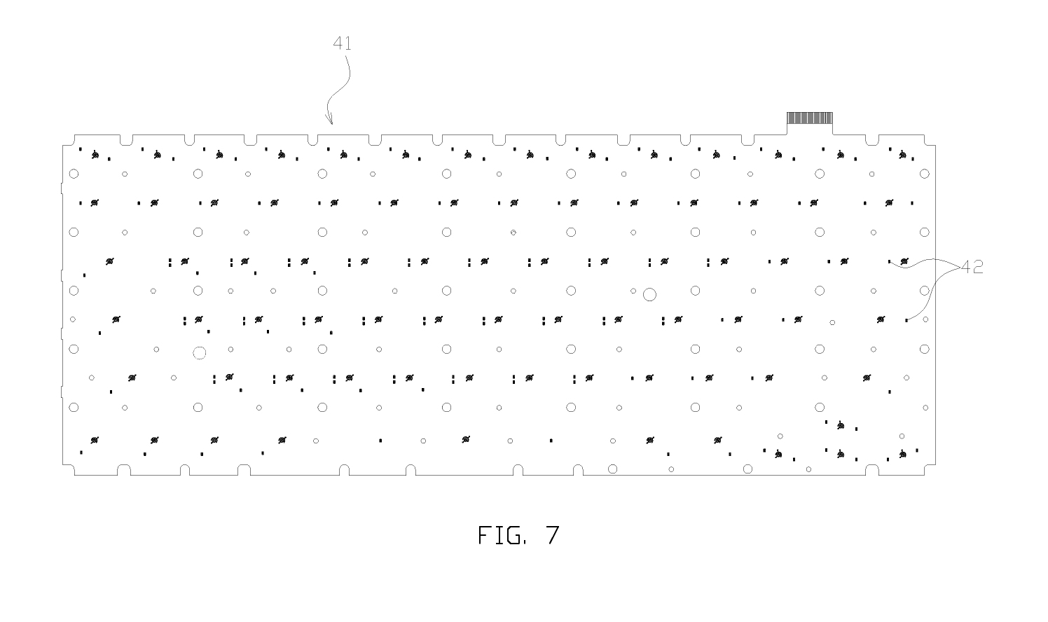

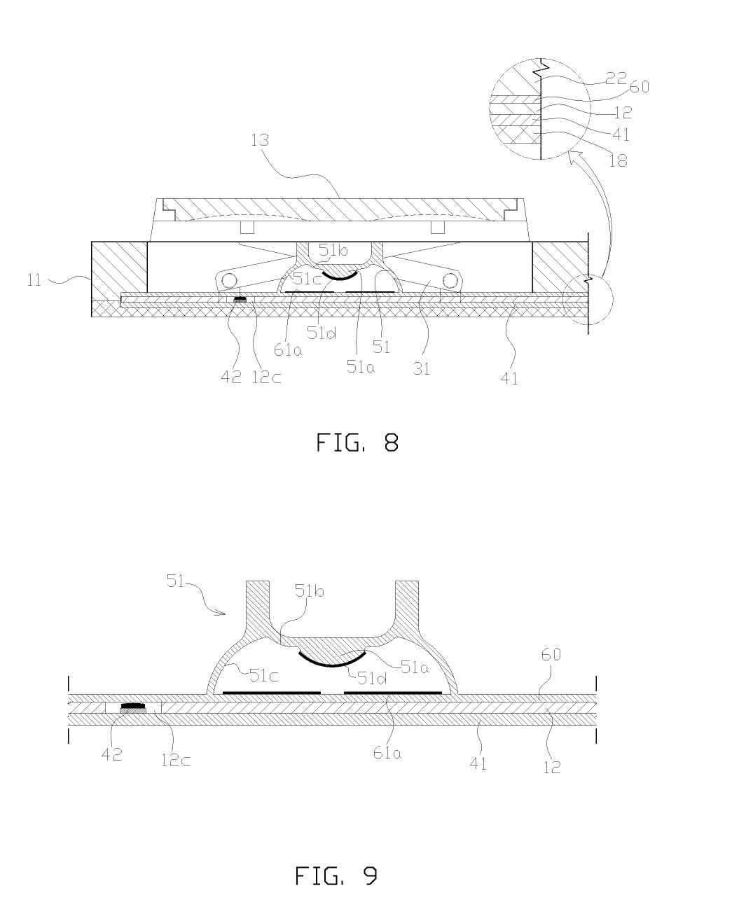

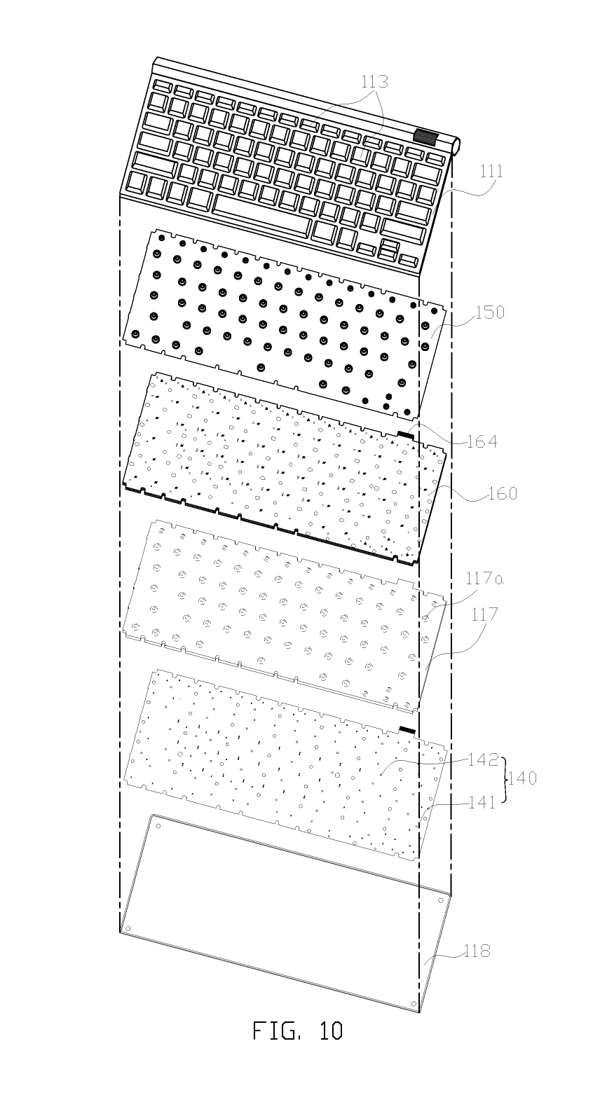

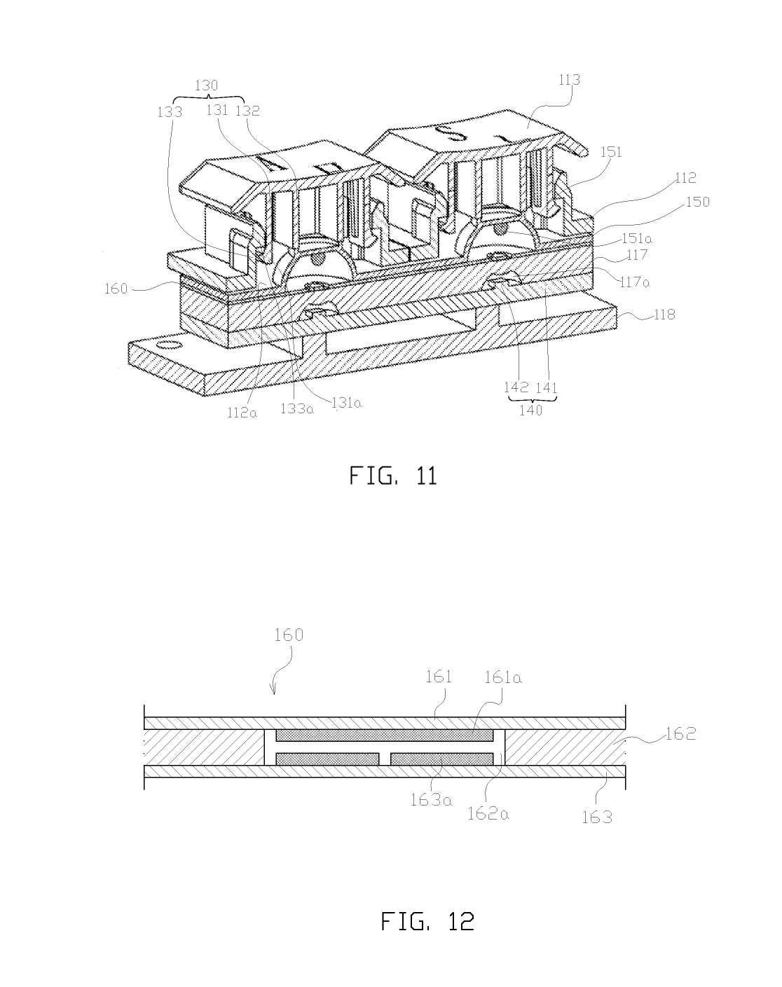

FIG. 1 is a view of a keyboard according to one embodiment of this invention. FIG. 2 is an exploded view of a keyboard according to one embodiment of this invention, the keyboard including a keycap support, a FPC sheet, a supporting panel, an light emitting substrate, and a elastomer. FIG. 3 is a rear view of the keyboard in FIG. 2. FIG. 4 is a view of the keycap support in FIG. 2. FIG. 5 is a plan view of the FPC sheet in FIG. 2. FIG. 6 is a plan view of the supporting panel in FIG. 2. FIG. 7 is a plan view of the light emitting substrate in FIG. 2. FIG. 8 is a cross-section view along line A-A in FIG. 1. FIG. 9 is an assembled view of the light emitting substrate, the cushion, the supporting panel and the elastomer.

The keyboard includes a keyboard shell 11, a support platform 20 formed on the keyboard shell 11, a supporting panel 12 arranged to the keyboard shell 11, a plurality of keycaps 13 disposed at upper side of the supporting panel 12, a keycap support 30, a FPC sheet 60 disposed at upper side of the supporting panel 12, a elastomer 51 formed in the FPC sheet 60, an light emitting substrate 41 disposed under the supporting panel 12, a plurality of light emitting members 42 disposed on the light emitting substrate 41, a main board (not shown) electrically connected to the FPC sheet 60 and the light emitting substrate 41, and a rear panel 18 disposed under the light emitting substrate 41.

The keyboard shell 11 in the illustrated embodiment is made of aluminum metal, and in other embodiments, the keyboard shell can also made of other metal materials or polyresin material.

The support platform 20 has a plurality of horizontal parts 21 and a plurality of vertical parts 22 intersecting wither each other and forming as a grid matrix. The horizontal parts 21 and vertical parts 22 have no interferences with the elastomer 51 and keycap support 30.

Four support protrusions 12b are formed corresponding to the keycap 13 in the supporting panel 12. A plurality of receiving holes 12c are formed therethrough along a thick direction.

The keycap support 30 includes a pair of connection parts in which the connection parts 31 are intersected with each other in a middle part, and upper parts and lower parts are connected to a support protrusion 12b of the keycap 13 and the supporting panel 12, which have a scissor shape.

The scissor shaped keycap support 30 uses normal technology and omitting the description.

Because of the keycap support 30, the keycap 13 moves to the upper side of the supporting panel 12 when pressed down.

The keycap support 30 can also have other shapes, such like, for example, mechanical structure to follow the keycap to go up and down along a guide rail.

The FPC sheet 60 has key signal pads 61a formed in accordance with keycaps 13.

Around the key signal pad 61a on the FPC sheet 60, the through hole 61b is formed to make support protrusions 12b protrude out from FPC sheet surface.

The FPC sheet 60 can be pasted to the supporting panel 12, and the FPC sheet 60 has a connection terminal 64 electrically connected to the key signal pad 61a and the main board.

The FPC sheet 60 is water resistant.

The elastomer 51 includes a top portion 51b, a flexible support portion 51c corresponding with the top portion 51b and having an arch shape extending from the top portion 51b, a pressure protrusion 51a formed on the bottom surface of top portion 51b, and a conductive layer 51d formed on the outside surface of the pressure protrusion 51a.

The elastomer 51 is dispose on the FPC sheet 60. When the keycap 13 is pressed down, the conductive layer 51d contacts the key signal pad 61a. The elastomer 51 is adhered to the FPC sheet 60 or integrated with the FPC sheet 60 into one piece.

When the keycap 13 is pressed, the conductive layer 51d contacts the key signal pad 61a, and the conductive layer 51d and the key signal pad 61a are in an ON state.

When the keycap 13 is released, the conductive layer 51d and the key signal pad 61a are detached and are in an OFF state.

The ON and OFF states of the conductive layer 51d and the key signal pad 61a are sent to a computer through the connection terminal 64 and the main board.

The light emitting substrate 41 is electrically connected with the main board.

The light emitting substrate 41 has illumination component driving chips disposed therein, which can drive the light emitting members to irradiate light beams according to control signals from an MCU IC of the keyboard or a computer through the main board.

The light emitting substrate 41 can be made from metal PCBs, Ceramic PCBs, or other PCBs that are temperature durable. It can be also made from flexible printed circuits (FPCs).

The illumination component 42 can be a light emitting diode.

The illumination component 42 is powered by a battery in the keyboard shell or from a computer.

The main board can be electrically or wirelessly connected to a computer through communication codes.

The rear panel 18 has a caved fixing portion and can be fastened with the keyboard shell using screw or other mechanical integration process.

The assemble method of the keyboard is described as following:

Firstly, the FPC sheet 60 is attached to the upper side of the supporting panel 12;

Secondly, from the bottom side of the supporting panel 12, the keyboard shell 11, the supporting panel 12 and FPC sheet 60 are connected together on the support platform 20;

Thirdly, the light emitting substrate 41 is fastened to the supporting panel 12 with screw;

Fourthly, when the substrate 41 and the FPC sheet 60 are disposed between the rear panel 18 and the keyboard shell 11, the rear panel 18 and the keyboard shell 11 are fastened together by using screw or other mechanical integration process;

Fifthly, the keycap support 30 is disposed on the supporting panel 12;

Finally, the keycap 13 is disposed on the keycap support 30.

In the illustrated embodiment, the FPC sheet 60 is a single-layer structure, meanwhile the elastomer 51 has the conductive layer 51d formed thereon, thus when the keycap 13 is pressed down, the pressure protrusion 51a is pressed and makes conductive layer 51d connect the key signal pad 61a formed on the FPC sheet due to the contact (ON state). Such single layer FPC sheet makes the keyboard thickness reduced.

Furthermore, the top side of the light emitting members 42 on the substrate 41 is not over the upper surface of the supporting panel 12 in thickness direction, so that a decrease of a contact area of the supporting panel 12 and the FPC sheet 6o can be effectively prevented.

What is claimed is:

1. A keyboard comprises a keyboard shell, a supporting panel arranged to the keyboard shell, a plurality of keycaps disposed at an upper side of the supporting panel, a plurality of keycap supports opposite to the supporting panel used for connecting the keycap to guide the keycap close to the upper side of the supporting panel when the keycap is pressed down, a plurality of elastomers arranged on the flexible printed circuit (FPC) sheet, and the elastomers passing through a plurality of elastomer through holes of the keycap support and exposing outside of the upper side of the supporting panel, an light emitting substrate disposed at a lower side of the supporting panel, a plurality of light emitting members disposed on the light emitting substrate corresponding with the keycaps, a FPC sheet arranged on the upper side of the supporting panel having key signal pads corresponding to the keycaps, and a flexible support portion of the elastomer having a top part and extending from the top part in an arch shape and a pressure protrusion of the elastomer formed on a bottom surface of the top part, and a conductive layer formed on the outside surface of the pressure protrusion;
in which the pressure protrusion is opposite to the key signal pad and when the keycap is pressed down, the pressure protrusion contacts the key signal pad on FPC, and the elastomer is supported by the flexible support portion;
in which the supporting panel has a plurality of receiving holes arranged along and pass through a thickness direction, and in which the light emitting members are received in the receiving holes.

2. The keyboard of claim 1, wherein the top side of light emitting members are not in excess of the surface of the upper side of the supporting panel on thickness direction and are mounted on the light emitting substrate.

3. The keyboard of claim 1, wherein the keycap support comprises a pair of connection parts in which the connection parts are intersected with each other in a middle part, and upper parts and lower parts are connected to a support protrusion of the keycap and the supporting panel respectively, and the keycap support connection parts have a scissor shape.

4. The keyboard of claim 1, wherein the elastomer is made from transparent materials.

5. The keyboard of claim 1, wherein the keyboard shell is made of aluminum or polyresin.
